(19) United States
(12) Patent Application Publication
(10) Pub. No.: US 2022/0229437 A1
(43) Pub. Date: Jul. 21, 2022

(54) TRAPPED STATE DETECTION METHOD AND MOBILE PLATFORM

(71) Applicant: ALi Corporation, Hsinchu (TW)

(72) Inventors: Shui-Shih CHEN, Hsinchu (TW); Tzu-Cheng HUANG, Hsinchu (TW)

(73) Assignee: ALi Corporation, Hsinchu (TW)

(21) Appl. No.: 17/546,058

(22) Filed: Dec. 9, 2021

Related U.S. Application Data
(60) Provisional application No. 63/138,795, filed on Jan. 19, 2021.

(30) Foreign Application Priority Data
Sep. 7, 2021 (CN) 202111043397.9

(51) Int. Cl. G05D 1/02

(52) U.S. Cl. CPC G05D 1/0214; G05D 1/027; G05D 1/0231

(57) ABSTRACT

Disclosed are a trapped state detection method and a mobile platform. The trapped state detection method is applied to the mobile platform including an actuator, and includes: selectively acquiring first signal characteristic or second signal characteristic in an external environment in a process in which the actuator drives the mobile platform to move; determining whether an abnormality occurs according to the first signal characteristic acquired in a first default time interval; controlling the actuator to perform a default verification behavior to change a position or a posture of the mobile platform when an occurrence of the abnormality is determined; determining whether another abnormality occurs according to the first signal characteristic or the second signal characteristic acquired in a second default time interval after the actuator performs the default verification behavior; and confirming that the mobile platform is in a trapped state when an occurrence of the another abnormality is determined.

### CROSS REFERENCE TO RELATED APPLICATION

This application claims the priority benefit of provisional application Ser. No. 63/138,795, filed on Jan. 19, 2021, and Chinese Patent Application Serial Number 202111043397.9, filed on Sep. 7, 2021, both of which are hereby incorporated by reference in their entireties.

### BACKGROUND

### Technical Field

The present disclosure relates to the technical field of mobile platforms, and in particular to a trapped state detection method and a mobile platform.

### Related Art

During the operation of a mobile platform in existence, a rotary encoder that converts an angular position into an output signal is used to calculate a distance that the mobile platform moves. However, during the operation, when the mobile platform is in a trapped state (for example, the mobile platform encounters an obstacle or moves on a smooth and moist ground), the wheels of the mobile platform slip due to idling, so that the distance detected by the rotary encoder does not match the actual moving distance of the mobile platform. If the mobile platform cannot determine that it is in the trapped state, it will not be able to correct the error caused by the trapping, so that accumulated errors may occur during operation, which leads to the failure of the positioning function of the mobile platform.

The relevant industry proposes to add complex calculations or use other sensors, such as inertial measurement units (IMUs), RGB-D cameras, and LiDARs, to determine whether the mobile platform is in the aforementioned trapped state. However, these methods greatly increase the cost of hardware and software.

### SUMMARY

The present disclosure provides a trapped state detection method and a mobile platform, which can effectively solve the problem that in the prior art, the costs of hardware and software are greatly increased due to the addition of complex calculations and sensors to determine whether the mobile platform is in the trapped state.

In order to solve the above technical problem, the present disclosure is implemented as follows.

In a first aspect, a trapped state detection method is provided. The trapped state detection method is applied to a mobile platform comprising an actuator, and comprises the steps of: selectively acquiring a first signal characteristic or a second signal characteristic in an external environment in a process in which the actuator drives the mobile platform to move; determining whether an abnormality occurs according to the first signal characteristic acquired during a first default time interval; controlling the actuator to perform a default verification behavior to change a position or a posture of the mobile platform when an occurrence of the abnormality is determined according to the first signal characteristic acquired during the first default time interval; determining whether another abnormality occurs according to the first signal characteristic or the second signal characteristic acquired during a second default time interval after the actuator performs the default verification behavior; and confirming that the mobile platform is in a trapped state when an occurrence of the another abnormality is determined according to the first signal characteristic or the second signal characteristic acquired during the second default time interval.

In a second aspect, a mobile platform is provided. The mobile platform comprises: an actuator, a sensing module, and a processing module, and the processing module is connected to the actuator and the sensing module. The actuator is configured to drive the mobile platform to move. The sensing module is configured to selectively acquire a first signal characteristic or a second signal characteristic in an external environment in a process in which the actuator drives the mobile platform to move. The processing module is configured to determine whether an abnormality occurs according to the first signal characteristic acquired during a first default time interval, control the actuator to perform a default verification behavior to change a position or a posture of the mobile platform when an occurrence of the abnormality is determined according to the first signal characteristic acquired during the first default time interval, determine whether another abnormality occurs according to the first signal characteristic or the second signal characteristic acquired during a second default time interval after the actuator performs the default verification behavior, and confirm that the mobile platform is in a trapped state when an occurrence of the another abnormality is determined according to the first signal characteristic or the second signal characteristic acquired during the second default time interval.

In the embodiments of the present disclosure, the signal characteristics existing in the external environment can be used to determine whether the mobile platform is in the trapped state, without the need for complex calculations or other sensors, which greatly increases the cost. In addition, after performing the default verification behavior, the mobile platform can confirm whether it is really in the trapped state, so that the detection accuracy of the trapped state is improved.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The FIGures are for illustration purposes only and are not drawn to scale. The exemplary embodiments, both as to organization and method of operation, may best be understood by reference to the detailed description which follows taken in conjunction with the accompanying drawings in which:

FIG. 1 is a block diagram of a mobile platform according to a first embodiment of the present disclosure.

FIG. 2 is a schematic flowchart of a trapped state detection method applied to the mobile platform of FIG. 1 according to a embodiment of the present disclosure.

FIG. 3 is a schematic flowchart of the step 210 in FIG. 2 according to a embodiment of the present disclosure.

FIG. 4 is a block diagram of a mobile platform according to a second embodiment of the present disclosure.

FIG. 5 is a schematic flowchart of a trapped state detection method applied to the mobile platform of FIG. 4 according to a embodiment of the present disclosure.

FIG. 6 is a block diagram of a mobile platform according to a third embodiment of the present disclosure.

FIG. 7 is a schematic flowchart of a trapped state detection method applied to the mobile platform of FIG. 6 according to a embodiment of the present disclosure.

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

It must be understood that when a component is described as being “connected” or “coupled” to (or with) another component, it may be directly connected or coupled to other components or through an intermediate component. In contrast, when a component is described as being “directly connected” or “directly coupled” to (or with) another component, there are no intermediate components. In addition, unless specifically stated in the specification, any term in the singular case also comprises the meaning of the plural case.

In the following embodiment, the same reference numerals are used to refer to the same or similar elements throughout the disclosure.

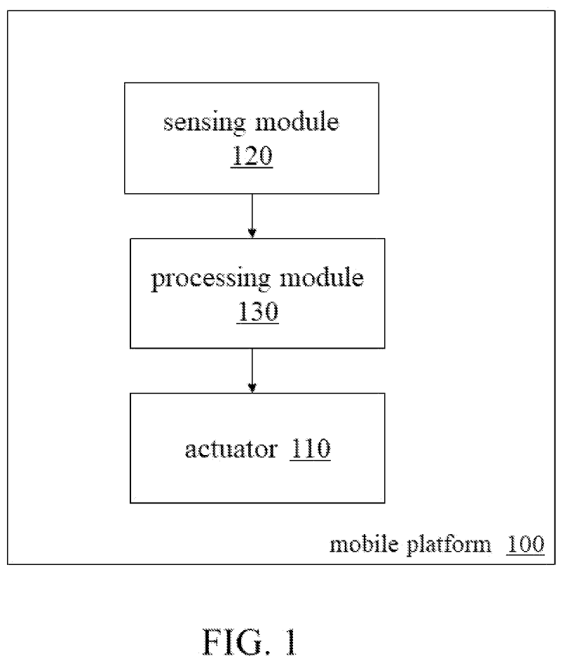

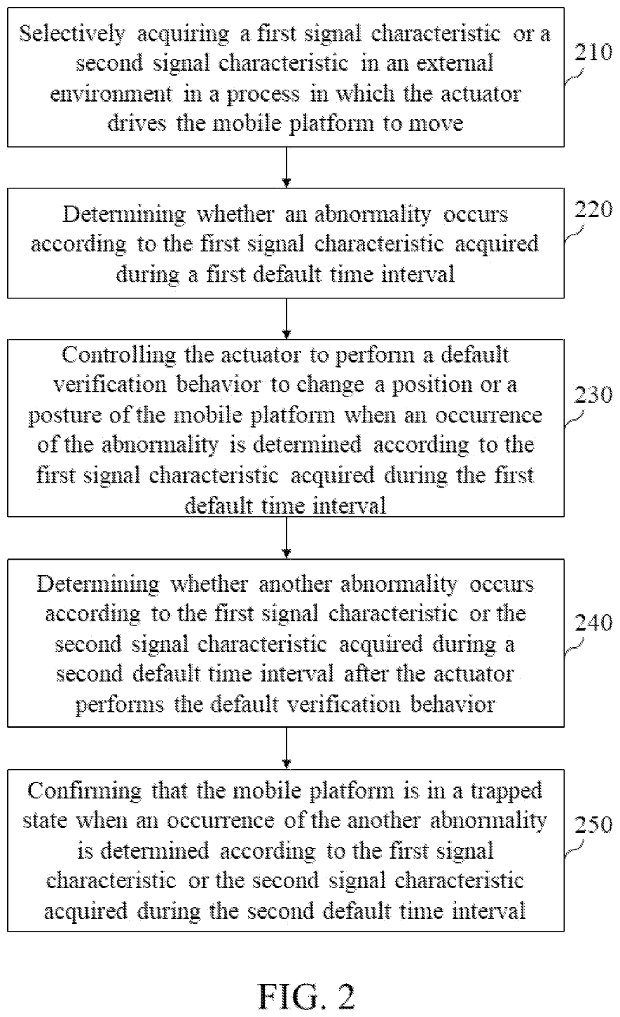

Please refer to FIGS. 1 and 2, wherein FIG. 1 is a block diagram of a mobile platform according to a first embodiment of the present disclosure, and FIG. 2 is a schematic flowchart of a trapped state detection method applied to the mobile platform of FIG. 1 according to a embodiment of the present disclosure. As shown in FIG. 1, the mobile platform 100 comprises: an actuator 110, a sensing module 120 and a processing module 130, and the processing module 130 is connected to the actuator 110 and the sensing module 120. The actuator 110, the sensing module 120, and the processing module 130 may be connected in a wireless or wired manner.

In this embodiment, the actuator 110 can be configured to drive the mobile platform 100 to move. That is, the actuator 110 can change the position and posture of the mobile platform 100. In an example, the actuator 110 may be, but is not limited to, a stepper motor, a servo motor, a piezoelectric motor, a voice coil motor, or a linear motor.

In this embodiment, the sensing module 120 can be configured to acquire a first signal characteristic or a second signal characteristic in an external environment. The processing module 130 can be configured to determine whether the mobile platform 100 is in a trapped state based on the first signal characteristic and/or the second signal characteristic and control the actuator 110 to drive the mobile platform 100 to move. Therefore, the trapped state detection method applied to the mobile platform 100 is executed by the sensing module 120 and the processing module 130 during the operation of the mobile platform 100, and the relevant description will be detailed later. In this embodiment, the first signal characteristic and the second signal characteristic are different.

In this embodiment, the processing module 130 may be a general-purpose processor, a digital signal processor (DSP), an application specific integrated circuit (ASIC), a field programmable gate array (FPGA) or other programmable logic device, a discrete component gate or a transistor logic device, or discrete hardware components.

Referring to FIG. 2, the trapped state detection method described in this embodiment comprises the following steps of: selectively acquiring a first signal characteristic or a second signal characteristic in an external environment in a process in which the actuator 110 drives the mobile platform 100 to move (step 210); determining whether an abnormality occurs according to the first signal characteristic acquired during a first default time interval (step 220); controlling the actuator 110 to perform a default verification behavior to change a position or a posture of the mobile platform 100 when an occurrence of the abnormality is determined according to the first signal characteristic acquired during the first default time interval (step 230); determining whether another abnormality occurs according to the first signal characteristic or the second signal characteristic acquired during a second default time interval after the actuator 110 performs the default verification behavior (step 240); and confirming that the mobile platform 100 is in a trapped state when an occurrence of the another abnormality is determined according to the first signal characteristic or the second signal characteristic acquired during the second default time interval. (step 250). In this embodiment, the step 210 is executed by the sensing module 120, and the step 220 to the step 250 are executed by the processing module 130. It should be noted that the second default time interval is after the first default time interval, and there is no overlap between the first default time interval and the second default time interval. The first default time interval and the second default time interval can be adjusted according to actual needs.

In one embodiment, the step 210 comprises: continuously acquiring the first signal characteristic or the second signal characteristic in the process in which the actuator 110 drives the mobile platform 100 to move. However, in order to avoid the continuous acquisition of the first signal characteristic or the second signal characteristic resulting in too much power consumption, the sensing module 120 can be preset to acquire the first signal characteristic during the first default time interval and acquire the first signal characteristic or the second signal characteristic during the second default time interval in the process in which the actuator 110 drives the mobile platform 100 to move.

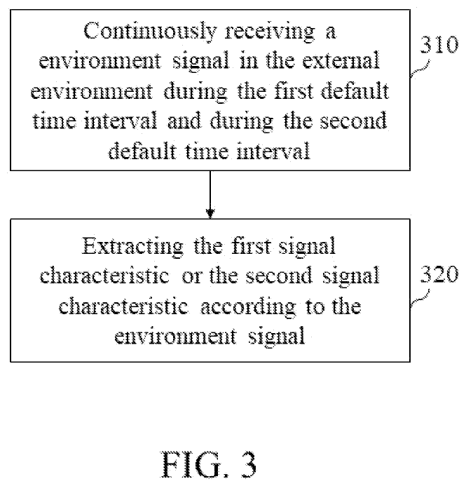

In an embodiment, please refer to FIG. 3, which is a schematic flowchart of the step 210 in FIG. 2 according to a embodiment of the present disclosure. As shown in FIG. 3, the step 210 comprises: continuously receiving a environment signal in the external environment during the first default time interval and during the second default time interval (step 310); and extracting the first signal characteristic or the second signal characteristic according to the environment signal (step 320). In more detail, the sensing module 120 may continuously receive the environment signal in the external environment during the first default time interval and during the second default time interval, wherein the environment signal comprises a plurality of different signal characteristics, so that the sensing module 120 may acquire the first signal characteristic or the second signal characteristic during the first default time interval and the second default time interval. It should be noted that the first signal characteristic and the second signal characteristic included in the environment signal need to have different feature values at different locations in the external environment (that is, the first signal characteristic and the second signal characteristic included in the environment signal vary with the position of the mobile platform 100).

In an example, the environment signal may be a wifi signal, and the first signal characteristic and the second signal characteristic may be the signal strength of the wifi signal, the angle of arrival of the wifi signal, or the arrival timestamp of the wifi signal, respectively, wherein the first signal characteristic and the second signal characteristic may be the same. In another example, the first signal characteristic and the second signal characteristic may be different.

In an example, the environment signal may be an electromagnetic signal, and the first signal characteristic and the second signal characteristic may be the signal strength of the electromagnetic signal, the angle of arrival of the electromagnetic signal, or the arrival phase of the electromagnetic signal, respectively, wherein the first signal characteristic and the second signal characteristic may be the same. In another example, the first signal characteristic and the second signal characteristic may be different.

In an example, the environment signal may be an acoustic signal, and the first signal characteristic and the second signal characteristic may be the signal strength of the acoustic signal, the angle of arrival of the acoustic signal, or the frequency of the acoustic wave signal, respectively, wherein the first signal characteristic and the second signal characteristic may be the same. In another example, the first signal characteristic and the second signal characteristic may be different.

Please refer to FIGS. 1 and 2. In one embodiment, the step 220 may comprise: comparing the first signal characteristic acquired at a current time with one or more of the first signal characteristics acquired at previous times during the first default time interval to determine whether the abnormality occurs. Based on the fact that the first signal characteristic varies with the position of the mobile platform 100, when the first signal characteristic acquired at the current time and one or more of the first signal characteristics acquired at previous times are the same during the first default time interval, the processing module 130 determines that an abnormality occurs.

In an example, the step 220 may comprise: comparing the first signal characteristic acquired at the current time with the first signal characteristic acquired at the previous time during the first default time interval to determine whether the abnormality occurs. Based on the fact that the first signal characteristic changes with different positions of the mobile platform 100, when the first signal characteristic acquired at the current time and the first signal characteristic acquired at the previous time during the first default time interval are the same, the processing module 130 determines that the abnormality occurs.

In another example, the step 220 may comprise: comparing a plurality of the first signal characteristics during the first default time interval to determine whether the abnormality occurs. Based on the fact that the first signal characteristic changes with different positions of the mobile platform 100, when the plurality of the first signal characteristics do not change during the first default time interval, the processing module 130 determines that the abnormality occurrs.

Please refer to FIGS. 1 and 2. In one embodiment, the step 230 of controlling the actuator 110 to perform the default verification behavior to change the position or the posture of the mobile platform 100, comprises: controlling the actuator 110 to make the mobile platform 100 move forward or rotate at any angle to change the position or posture of the mobile platform 100.

Please refer to FIGS. 1 and 2. In one embodiment, the step 240 of determining whether the abnormality occurs according to the first signal characteristic or the second signal characteristic acquired during the second default time interval, comprises: comparing the first signal characteristic acquired at the current time with one or more of the first signal characteristics acquired at the previous times during the second default time interval to determine whether the another abnormality occurs; or comparing the second signal characteristic acquired at the current time with one or more of the second signal characteristics acquired at the previous times during the second default time interval to determine whether the another abnormality occurs. Based on the fact that the first signal characteristic or the second signal characteristic changes with different positions of the mobile platform 100, when the first signal characteristic acquired at the current time and one or more of the first signal characteristics acquired at previous times are the same during the second default time interval, or the second signal characteristic acquired at the current time and one or more of the second signal characteristics acquired at previous times are the same during the second default time interval, the processing module 130 determines that the another abnormality occurs.

In an example, the step 240 may comprise: comparing the first signal characteristic acquired at the current time with the first signal characteristic acquired at the previous time during the second default time interval to determine whether the another abnormality occurs; or comparing a plurality of the first signal characteristics durig the second default time interval to determine whether the another abnormality occurs. Based on the fact that the first signal characteristic changes with the position of the mobile platform 100, when the plurality of the first signal characteristics do not change during the second default time interval, the processing module 130 determines that an abnormality occurrs.

In another example, the step 240 may comprise: comparing the second signal characteristic acquired at the current time with the second signal characteristic acquired at the previous time during the second default time interval to determine whether the another abnormality occurs; or comparing a plurality of the second signal characteristics during the second default time interval to determine whether the another abnormality occurs. Based on the fact that the second signal characteristic changes with the position of the mobile platform 100, when the plurality of the second signal characteristics do not change during the second default time interval, the processing module 130 determines that the another abnormality occurrs.

Therefore, the first signal characteristic and the second signal characteristic existing in the external environment can be used to determine whether the mobile platform 100 is in the trapped state through the above steps 210 to 250, and the cost of the sensing module 120 for acquiring the first signal characteristic and the second signal characteristic is lower than that of the complicated calculations and sensors required in the prior art. In addition, after performing the default verification behavior, the mobile platform can confirm whether it is really in the trapped state, so that the detection accuracy of the trapped state is improved.

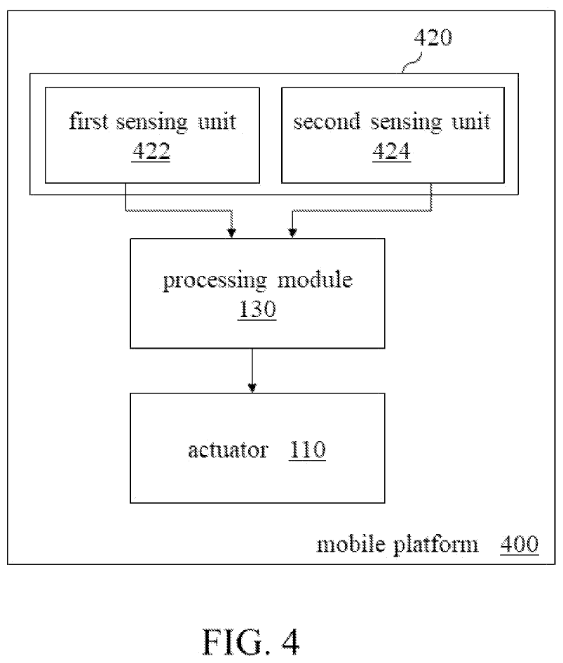

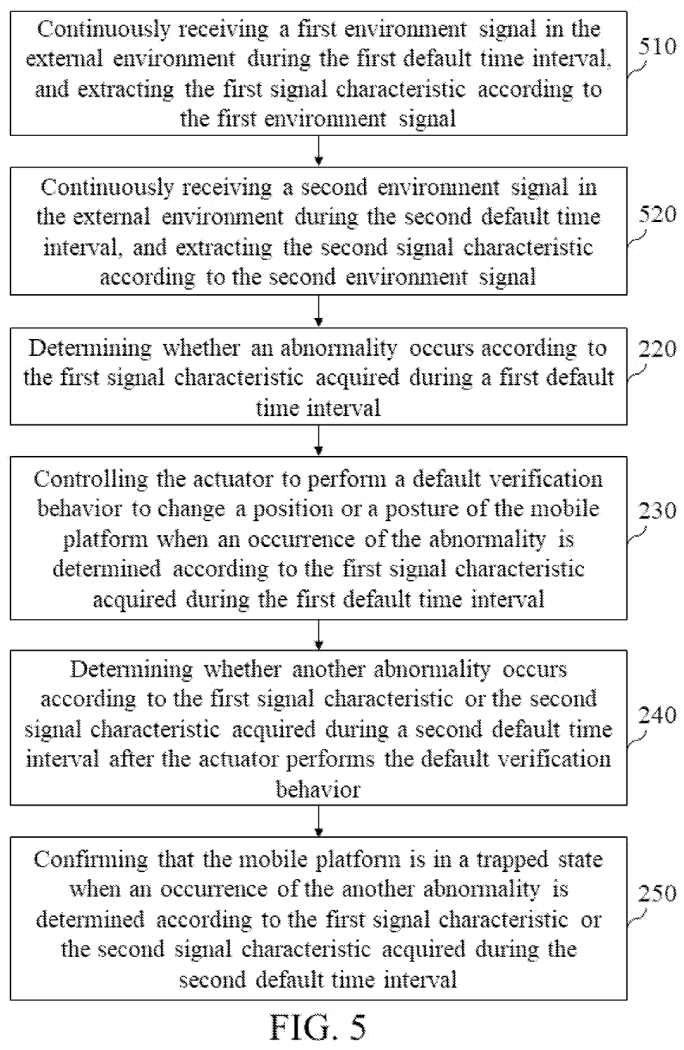

In an embodiment, please refer to FIGS. 4 and 5, wherein FIG. 4 is a block diagram of a mobile platform according to a second embodiment of the present disclosure, and FIG. 5 is a schematic flowchart of a trapped state detection method applied to the mobile platform of FIG. 4 according to a embodiment of the present disclosure. As shown in FIG. 4, the difference between this embodiment and the first embodiment is that the sensing module 420 of the mobile platform 400 can comprise a first sensing unit 422 and a second sensing unit 424, so that in the trapped state detection method applied to the mobile platform 400, the step 210 in FIG. 2 can be replaced with the step 510 and the step 520 in FIG. 5. The step 510 is performed by the first sensing unit 422, and the step 520 is performed by the second sensing unit 424. The step 510 comprises: continuously receiving a first environment signal in the external environment during the first default time interval, and extracting the first signal characteristic according to the first environment signal. The step 520 comprises: continuously receiving a second environment signal in the external environment during the second default time interval, and extracting the second signal characteristic according to the second environment signal. In other words, the first sensing unit 422 and the second sensing unit 424 are used to receive different environment signals at different times, and the first signal characteristic and the second signal characteristic vary with the position of the mobile platform 400.

In an example, the first environment signal and the second environment signal may be a wifi signal, an electromagnetic signal, or an acoustic signal, respectively, and the first environment signal and the second environment signal are different, wherein the first signal characteristic may be the signal strength, the angle of arrival, the arrival timestamp, the arrival phase or the frequency of the first environment signal, and the second signal characteristic may be the signal strength, the angle of arrival, the arrival timestamp, the arrival phase or the frequency of the second environment signal.

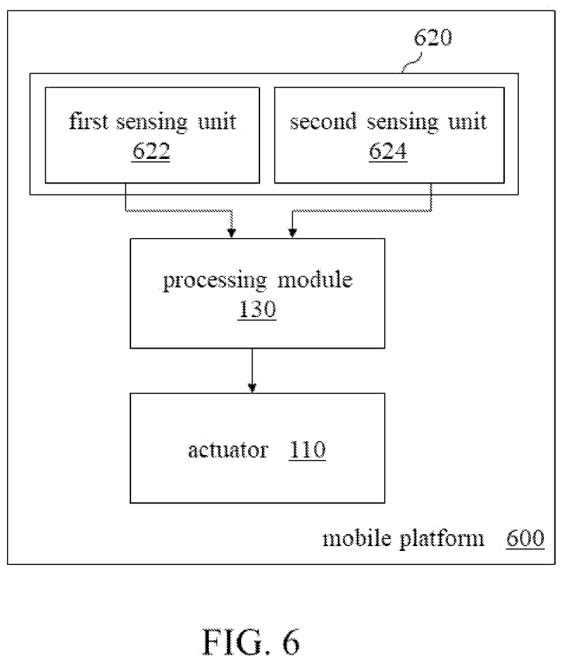

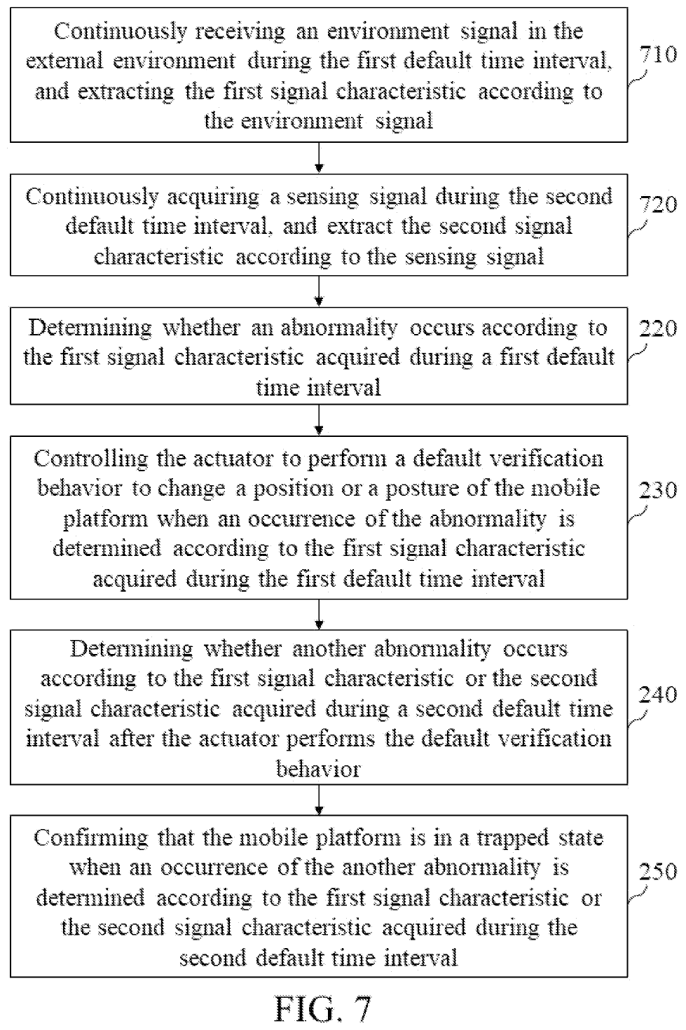

In an embodiment, please refer to FIGS. 6 and 7, wherein FIG. 6 is a block diagram of a mobile platform according to a third embodiment of the present disclosure, and FIG. 7 is a schematic flowchart of a trapped state detection method applied to the mobile platform of FIG. 6 according to a embodiment of the present disclosure. As shown in FIG. 6, the difference between this embodiment and the first embodiment is that the sensing module 620 of the mobile platform 600 can comprise a first sensing unit 622 and a second sensing unit 624, so that in the trapped state detection method applied to the mobile platform 600, the step 210 in FIG. 2 can be replaced with the step 710 and the step 720 in FIG. 7. The step 710 is performed by the first sensing unit 622, and the step 720 is performed by the second sensing unit 624. The step 710 comprises: continuously receiving an environment signal in the external environment during the first default time interval, and extracting the first signal characteristic according to the environment signal. The step 720 comprises: continuously acquiring a sensing signal during the second default time interval, and extract the second signal characteristic according to the sensing signal. In other words, the first sensing unit 622 is used for receiving the environment signal based on the external environment, while the second sensing unit 624 is used for acquiring the sensing signal based on the external environment, and the first signal characteristic and the second signal characteristic vary with the position of the mobile platform 600.

In an example, the environment signal may be a wifi signal, an electromagnetic signal, or an acoustic signal, and the first signal characteristic may be the signal strength, the angle of arrival, the arrival timestamp, the arrival phase or the frequency of the environment signal. When the second sensing unit 624 can be a LiDAR, the second signal characteristic can be depth information or positioning information. When the second sensing unit 624 can be a camera, the second signal characteristic can be feature points or positioning information. When the second sensing unit 624 can be a TOF camera, the second signal characteristic can be depth information. When the second sensing unit 624 can be an IMU, the second signal characteristic may be linear acceleration information, angular velocity information or magnetic field information.

In summary, the trapped state detection method and the mobile platform of the embodiments of the present disclosure can determine whether the mobile platform is in the trapped state through signal characteristics existing in the external environment, without the need for complex calculations or other sensors, which greatly increases the cost. In addition, after performing the default verification behavior, the mobile platform can confirm whether it is really in the trapped state, so that the detection accuracy of the trapped state is improved.

It is to be understood that the term “comprises”, “comprising”, or any other variants thereof, is intended to encompass a non-exclusive inclusion, such that a process, method, article, or device of a series of elements not only comprise those elements but also comprises other elements that are not explicitly listed, or elements that are inherent to such a process, method, article, or device. An element defined by the phrase “comprising a . . . ” does not exclude the presence of the same element in the process, method, article, or device that comprises the element.

Although the present disclosure has been explained in relation to its preferred embodiment, it does not intend to limit the present disclosure. It will be apparent to those skilled in the art having regard to this present disclosure that other modifications of the exemplary embodiments beyond those embodiments specifically described here may be made without departing from the spirit of the disclosure. Accordingly, such modifications are considered within the scope of the disclosure as limited solely by the appended claims.

What is claimed is:

1. A trapped state detection method, which is applied to a mobile platform comprising an actuator, comprising the following steps of:
selectively acquiring a first signal characteristic or a second signal characteristic in an external environment in a process in which the actuator drives the mobile platform to move;
determining whether an abnormality occurs according to the first signal characteristic acquired during a first default time interval;
controlling the actuator to perform a default verification behavior to change a position or a posture of the mobile platform when an occurrence of the abnormality is determined according to the first signal characteristic acquired during the first default time interval;
determining whether another abnormality occurs according to the first signal characteristic or the second signal characteristic acquired during a second default time interval after the actuator performs the default verification behavior; and
confirming that the mobile platform is in a trapped state when an occurrence of the another abnormality is determined according to the first signal characteristic or the second signal characteristic acquired during the second default time interval.

2. The trapped state detection method according to claim 1, wherein the step of selectively acquiring the first signal characteristic or the second signal characteristic in the external environment in the process in which the actuator drives the mobile platform to move, comprises:
continuously receiving an environment signal in the external environment during the first default time interval and during the second default time interval; and
extracting the first signal characteristic or the second signal characteristic according to the environment signal.

3. The trapped state detection method according to claim 1, wherein the step of selectively acquiring the first signal characteristic or the second signal characteristic in the external environment in the process in which the actuator drives the mobile platform to move, comprises:
continuously receiving a first environment signal in the external environment during the first default time interval, and extracting the first signal characteristic according to the first environment signal; and
continuously receiving a second environment signal in the external environment during the second default time interval, and extracting the second signal characteristic according to the second environment signal.

4. The trapped state detection method according to claim 1, wherein the step of selectively acquiring the first signal characteristic or the second signal characteristic in the external environment in the process in which the actuator drives the mobile platform to move, comprises:
continuously receiving an environment signal in the external environment during the first default time interval, and extracting the first signal characteristic according to the environment signal; and
continuously acquiring a sensing signal during the second default time interval, and extracting the second signal characteristic according to the sensing signal.

5. The trapped state detection method according to claim 1, wherein the step of determining whether the abnormality occurs according to the first signal characteristic acquired during the first default time interval, comprises:
comparing the first signal characteristic acquired at a current time with one or more of the first signal characteristics acquired at previous times during the first default time interval to determine whether the abnormality occurs.

6. The trapped state detection method according to claim 1, wherein the step of determining whether the another abnormality occurs according to the first signal characteristic or the second signal characteristic acquired during the second default time interval, comprises:
comparing the first signal characteristic acquired at a current time with one or more of the first signal characteristics acquired at previous times during the second default time interval to determine whether the another abnormality occurs; or
comparing the second signal characteristic acquired at a current time with one or more of the second signal characteristics acquired at previous times during the second default time interval to determine whether the another abnormality occurs.

7. A mobile platform, comprising:
an actuator configured to drive the mobile platform to move;
a sensing module configured to selectively acquire a first signal characteristic or a second signal characteristic in an external environment in a process in which the actuator drives the mobile platform to move; and
a processing module connected to the actuator and the sensing module, and configured to determine whether an abnormality occurs according to the first signal characteristic acquired during a first default time interval, control the actuator to perform a default verification behavior to change a position or a posture of the mobile platform when an occurrence of the abnormality is determined according to the first signal characteristic acquired during the first default time interval, determine whether another abnormality occurs according to the first signal characteristic or the second signal characteristic acquired during a second default time interval after the actuator performs the default verification behavior, and confirm that the mobile platform is in a trapped state when an occurrence of the another abnormality is determined according to the first signal characteristic or the second signal characteristic acquired during the second default time interval.

8. The mobile platform according to claim 7, wherein the sensing module is further configured to continuously receive an environment signal in the external environment during the first default time interval and during the second default time interval, and extract the first signal characteristic or the second signal characteristic according to the environment signal.

9. The mobile platform according to claim 7, wherein the sensing module further comprises a first sensing unit and a second sensing unit; the first sensing unit is configured to continuously receive a first environment signal in the external environment during the first default time interval, and extract the first signal characteristic according to the first environment signal; and the second sensing unit is configured to continuously receive a second environment signal in the external environment during the second default time interval, and extract the second signal characteristic according to the second environment signal.

10. The mobile platform according to claim 7, wherein the sensing module further comprises a first sensing unit and a second sensing unit; the first sensing unit is configured to continuously receive an environment signal in the external environment during the first default time interval, and extract the first signal characteristic according to the environment signal; the second sensing unit is configured to continuously acquire a sensing signal during the second default time interval, and extract the second signal characteristic according to the sensing signal.

11. The mobile platform according to claim 10, wherein the second sensing unit is a LiDAR, a camera, a TOF camera, or an inertial measurement unit.

12. The mobile platform according to claim 7, wherein the processing module is further configured to compare the first signal characteristic acquired at a current time with one or more of the first signal characteristics acquired at previous times during the first default time interval to determine whether the abnormality occurs.

13. The mobile platform according to claim 7, wherein the processing module is further configured to compare the first signal characteristic acquired at a current time with one or more of the first signal characteristics acquired at previous times during the second default time interval to determine whether the another abnormality occurs; or compare the second signal characteristic acquired at a current time with one or more of the second signal characteristics acquired at previous times during the second default time interval to determine whether the another abnormality occurs.

14. The mobile platform according to claim 7, wherein the first signal characteristic and the second signal characteristic are different.
